(19) United States
(12) Patent Application Publication
(10) Pub. No.: US 2004/0222340 A1
(43) Pub. Date: Nov. 11, 2004

(54) Camera mount

(76) Inventor: Paul William Richardson, Leigh-on-Sea (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/810,914

(22) Filed: Mar. 26, 2004

(30) Foreign Application Priority Data
Mar. 28, 2003 (GB) 03 07180.0

(51) Int. Cl. F16M 13/00

(52) U.S. Cl. 248/176.1; 248/158; 248/178.1

(57) ABSTRACT

A camera mount intended for an essentially permanent fixing to the ground at a chosen site such as at a scenic view or theme park to facilitate self-photography has a base member for bolting to the ground, such as to a concrete plinth. A column upstands from the base and carries at its upper end a camera platform having an upper camera mounting surface. A rotatable standard camera mount screw projects from the camera mounting surface whereby a camera may be secured thereto. The camera mounting surface may be adjustable at least about a horizontal axis to permit framing when taking a photograph.

### BACKGROUND TO THE INVENTION

1. Field of the Invention

This invention relates to a camera mount enabling self-photography.

2. Description of the Prior Art

It frequently happens that people wish to take a photograph at some well-known or attractive site and would like to have themselves included in the photograph, perhaps with other family members or friends, and with a particular backdrop or vista behind those being photographed. In order to achieve this, the photographer has to ask some other member of the public to take the photograph presuming there is someone else at the same site. The photographer then has to lend the camera to that other member of the public and also has to rely on that person properly to frame the picture and operate the camera. Not surprisingly, photographs taken in this way often do not come up to the hoped-for standard of the photographer and there is always the risk that the member of the public might abscond with the camera.

The simple solution to this difficulty is for the photographer to have a tripod which he carries around with him, so it is available for use on the rare occasions it might be needed. Unfortunately, a good tripod is relatively heavy and in general a typical tourist would not wish to carry a tripod which can be erected as and when needed. On the other hand, a significantly lighter tripod might be easier to carry around but will be relatively weak and lack stability, especially for use out of doors. As a consequence, few tourists carry tripods.

A principal aim of the present invention is to address this problem of a photographer taking a self-portrait or picture including the photographer, as well as perhaps with other people, at a recognised location where people frequently wish to take photographs.

### SUMMARY OF THE INVENTION

According to the present invention, there is provided a camera mount comprising a base adapted for essentially permanent fixing to the ground at a chosen site, and a support upstanding from the base and having at its upper end a camera platform. The camera platform has a mounting surface from which projects a rotatable standard camera mount screw whereby a camera may be temporarily mounted on the platform by a photographer. When a camera has been mounted on the platform the taking of a self-portrait of the photographer with the backdrop predefined by the location of the base at the chosen site becomes possible.

The camera mount of this invention typically would be provided as an essentially permanent installation, by an owner of the site as a service to visitors to the site and who might wish to take photographs. For example, it could be provided by a local council at a well-known beauty spot where the backdrop to the photograph could be the view from that beauty spot. It could be provided at a theme park by the operator of the theme park where people might wish to have a photograph taken—for instance in front of a particular feature at that park. Other possibilities include the provision of the camera mount before a painted wall with at least one cut-out portion through which someone may offer his head to give the impression that that person is a part of the painted picture—a so-called “end-of-pier” picture.

The camera mount gives security for the camera, since the camera is secured by the owner to the mount, using the mount screw. As the camera mount is essentially permanently fixed to the ground, the camera cannot be removed by a third party unless the mount screw is first unscrewed from the camera—and since this would take some time, it would give the owner of the camera adequate opportunity to prevent such inappropriation of the camera.

Most cameras are provided with a socket in the base of the camera with a standardised thread, and so the provision of a standard mount screw on the camera mount of this invention is wholly realistic. However, to cover a situation where a camera might have a socket with a non-standard thread, the camera mounting surface of the camera platform might have a hole of an appropriate diameter and through which a photographer could insert his own camera screw, which matches the thread of his camera. The carrying of such a screw would be no significant burden, especially as compared to the alternative of carrying a substantial tripod to permit use of the camera in the manner discussed above.

### BRIEF DESCRIPTION OF THE DRAWINGS

A preferred embodiment of the invention is described in the accompanying drawings, though only by way of example. In the drawings:

FIG. 1 is a part-sectional side view of a first embodiment of camera mount of this invention;

FIG. 2 is a plan view on the mount of FIG. 1;

FIG. 3 is a partial front view on the mount of FIG. 1;

FIG. 4 diagrammatically illustrates the installation of the camera mount of FIGS. 1 to 3;

FIG. 5 is a detail view on an enlarged scale of a modified form of camera platform for use with the first embodiment; and

FIG. 6 is a part-sectional view of a second embodiment.

### DESCRIPTION OF THE PREFERRED EMBODIMENTS

In a preferred embodiment of this invention, the camera platform is arranged for lockable pivoting motion about at least one axis and advantageously about a horizontal axis, so as to permit the appropriate framing of a picture to be taken. The camera may be appropriately set about a vertical axis merely by tightening the mount screw when the camera has been set to point in the required direction.

The support may be in the form of a substantially rigid column upstanding from the base and having the camera platform at its upper end. At its simplest, the base may be of a simple geometric shape such as square or circular, the column a circular tube and the platform also of a simple geometric shape. The construction should be sufficiently massive to be resistant to vandalism and so might be made of a material such as stainless steel or other strong material resistant to corrosion.

A particularly preferred form of the camera mount has a support which provides at least one surface for carrying information. That information could merely be relevant to the site at which the mount is provided, but advantageously the information is advertising for which a charge could be made to the advertiser by the provider of the mount. For example, the support could include one or more generally planar surfaces on which advertising material could be displayed. Yet another possibility is for the support to include a shroud which encloses the space between the base and the platform, which shroud is suitably profiled so as to have a recognisable shape. That shape could itself be advertising material—for example, it could be in the shape of a 35 mm or other film container and also carry the logo or other indicia of a film maker. Other possibilities might be for the shape to be in the form of an ice cream, a well-known cartoon character and so on—many other possibilities will spring to mind to those skilled in the art.

If an electricity supply is available, then the mount could be illuminated. By providing a translucent shroud, its attractiveness may be enhanced. Further, it may include a floodlight to illuminate the area where people are to stand, which floodlight may include a timer-switch so as to be on for only a relatively short period, when required.

In addition, the camera mount may have an audio or audio/visual explanation system to tell people what it is for and how to use it. Though such a system could be switch-triggered, preferably it is a solid-state system and has a proximity detector so as to be triggered when a person approaches the mount.

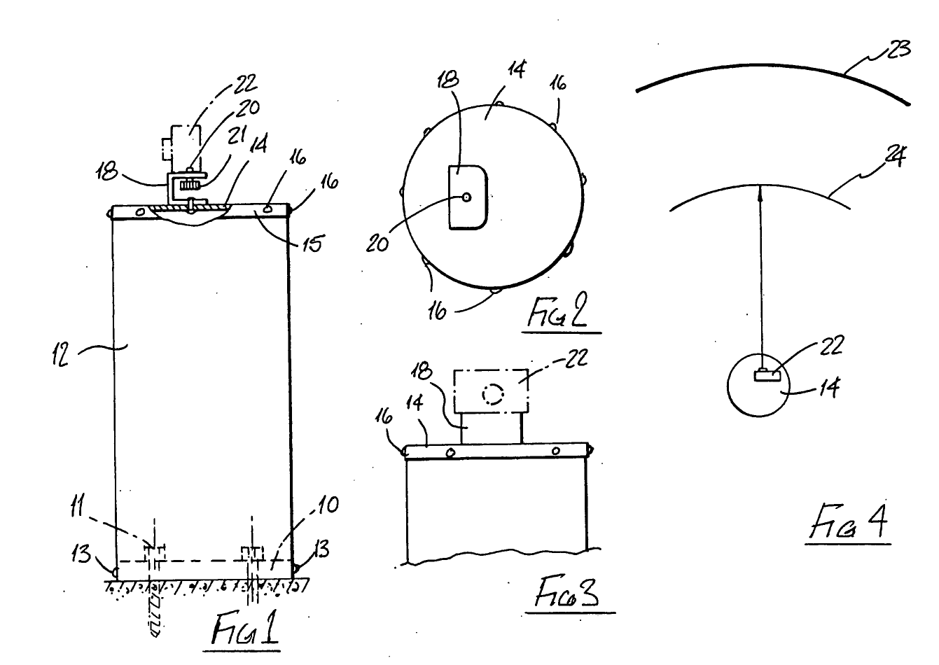

A preferred embodiment of the camera mount will now be described, referring initially to FIGS. 1 to 3. The camera mount comprises a base plate 10 of circular form and which is secured to the ground by means of internal bolts 11, at a chosen site where the camera mount is to be furnished. A concrete pad may be provided in the ground, for this purpose. A generally cylindrical tube 12 upstands from the base plate 10, the tube encircling the base plate and being attached thereto by means of security fasteners 13 extending generally radially into the base plate. The tube 12 has at its upper end a cover plate 14 which has a rim 15 encircling the tube. The cover plate is attached to the tube by means of further security fasteners 16 extending generally radially and threaded into the tube.

The upper surface of the cover plate 14 has a U-shaped bracket 18 secured thereto by one arm of the bracket, such that the upper arm 19 extends generally horizontally above the surface of the cover plate 14, to serve as a camera platform. A camera mount screw 20 is rotatably mounted in the upper arm 19 of the bracket, that screw having a manually-grippable knob 21 disposed below the upper arm 19. The screw is held captive in the arm for example by means of a circlip provided on the screw and received in a counter-bore formed in the upper surface of the arm 19. The portion of the screw projecting above the upper surface of the upper arm is of a standardised thread, so as to be receivable in the majority of modern cameras. Thus, a typical camera 22 may be attached to the U-shaped bracket by appropriate manipulation of the knob 21. To give sufficient strength and durability, the knob may be provided on a boss rotatably mounted in the arm 19, only the screw-threaded part of the mount screw projecting above the upper surface of arm 19.

The gap between the two arms of the bracket 18 should be relatively small, to allow only finger access to the knob 21. In this way, the likelihood of excessive tightening of the knob can be reduced, as can be the probability of damage through vandalism or other causes.

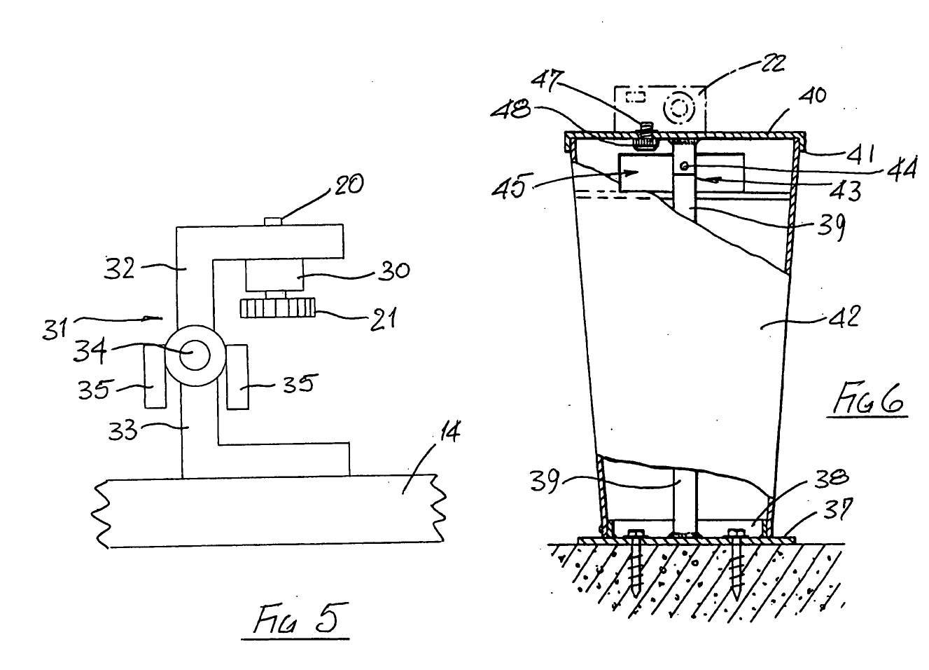

In this embodiment, the position of the camera is defined by the provision of the mount at a required site and the only adjustment which can be achieved is about a vertical axis, as the knob 21 is tightened. Thus, the view which can be framed by the camera is essentially pre-defined by the installation of the camera mount at the required site, as illustrated in FIG. 4. In the case where there is a backdrop 23 which is to be captured as well as a principal object to be photographed and which is positioned on the line marked 24, that backdrop and the line 24 should be juxtaposed to the camera mount such that for a fixed focus camera both will be in focus. Other markings may be provided on the ground to indicate where someone should stand to be included in a photograph, such as metallic marker plates let into the ground and possibly carrying interesting or useful information. When an auto-focussing or variable focus camera is employed, then there is no need for concern over the precise positioning of the backdrop or the point at which objects to be photographed should be positioned.

The external cylindrical surface of the tube 12 may carry a variety of information, depending upon the needs of the provider of the camera mount. For example, when the camera mount is installed at a beauty spot or other area presenting a spectacular vista, that surface may be used to give information about the view from that site. Alternatively, advertising material may be provided on the cylindrical surface. If required, one or more flat panels may be incorporated in the tube 12, better to display such advertising material. Another possibility would be to provide a square base plate 10 and a square cover plate 14, the tube 12 also being of square cross-section and so directly providing four planar surfaces for carrying advertising or other information.

Though not shown in the drawings, the counter-bore in the upper surface of the arm 19 may be sufficiently deep such that when the circlip on the camera mount screw 20 bears on the bottom of the counter-bore, no part of the screw 20 projects upwardly from that upper surface. This minimises the likelihood of the threaded part being damaged and also obviates the possibility of someone being hurt or injured by a projecting screw. When the screw is to be used temporarily to secure a camera to the arm 19, the screw must first be pushed upwardly before being turned, to permit the screw to engage the threaded bore in the camera. Other measures may instead be taken to minimise the likelihood of injury—for example, a spring-loaded retractable cover sleeve for the screw.

FIG. 5 shows a modified form of bracket 18, permitting greater adjustability. The bracket 26 has a lower arm 27 secured to the cover plate 14 of the principal part of the mount, and an upper arm 28 which rotatably carries the camera screw 20. As shown in FIG. 5, that screw is journalled in a boss 30 provided on the lower surface of the upper arm 28, so permitting the furnishing of a relatively massive shaft and knob 21, from which the relatively small camera mount screw 20 may project.

The web 31 of the I bracket is in two parts 32 and 33 pivoted together by a threaded shaft 34, a clamp knob (not shown) being provided on the shaft to permit clamping of the pivotal connection at a desired setting. Two stops 35 are provided to limit pivoting movement of the upper arm 28 to pre-defined angles. By providing the modified form of bracket on the cover plate, a user of the camera mount may be able better to frame the picture to be taken.

FIG. 6 shows a second embodiment of camera mount of this invention. In this embodiment, the base plate 37 is circular and has an upstanding circular flange 38 disposed concentrically with a pillar 39, also upstanding from the base plate. At its upper end, the pillar supports a cover plate 40 having a downturned lip 41, a shroud 42 extending between the base plate and the cover plate and being located by the flange 38 and lip 41. To permit the provision of the shroud as described, the pillar 39 is in two parts held together by a joint 43 having a securing pin 44 accessible through one or more apertures 45 provided in the upper part of the shroud. Typically, there may be two rectangular apertures diametrically opposed as shown in the drawing. A baffle 46 may be furnished within the shroud 42 at the level of the bottom edges of the apertures, to prevent litter, debris or other unwanted matter being deposited into the shroud, through the apertures.

A camera mount screw 47 extends through a hole provided in the cover plate 40, that screw having below the cover plate a knob 48 and projecting above that cover plate a standardised camera thread. The knob is accessible through either of the apertures 45 but in view of the limited access to that knob, it will be difficult to over-tighten the knob or otherwise subject it to abuse or vandalism.

The described embodiments of this invention are used by being secured to the ground in an essentially permanent manner, and facing a view or other object to be photographed. That view might be a panoramic vista, in which case the photographer might choose exactly which direction to point the camera on tightening the mount screw 20 or 27 as appropriate. In the case of a feature such as a building or other object such as might be encountered at a theme park, the direction in which the camera should be pointed is more or less fixed but it is still open to the photographer to choose and ensure the camera is appropriately aligned.

So long as the camera remains temporarily secured to the camera platform of the mount, the camera is held against movement by wind or other accidental cause. Further, the threaded attachment of the camera prevents its easy theft when the photographer is a few metres away from it, which otherwise could occur if the camera were to be merely placed on a wall or other surface, or lent to a third party to take the required photograph.

Once the camera has been secured to the mount by tightening the mount screw, the photographer organises such other people who are to appear in the photograph at the appropriate position and the camera is set to take a delayed photograph. The camera is triggered and the photographer quickly moves to the marks on the ground to be in the field of view of the camera, so as to appear in the photograph. Once completed, the photographer removes his camera by unscrewing the mount screw and the camera mount is available for the next intending user.

1. A camera mount comprising a base adapted for essentially permanent fixing to the ground at a chosen site, a support upstanding from the base and having an upper end, a camera platform provided at the upper end of the support, said camera platform having a camera mounting surface, and a rotatable standard camera mount screw projecting from the camera mounting surface, whereby a camera may be temporarily mounted on the platform by a photographer to facilitate the taking of a self-portrait of the photographer with a backdrop predefined by the fixing of the base at the chosen site.

2. A camera mount as claimed in claim 1, wherein the mount screw is provided on a boss rotatably mounted on the camera platform, with only a threaded part of the mount screw being capable of projecting above the upper surface of the platform.

3. A camera mount as claimed in claim 1, wherein the camera platform is adjustable about at least one axis.

4. A camera mount as claimed in claim 3, wherein the camera mount is adjustable about a horizontal axis.

5. A camera mount as claimed in claim 1, wherein the support is in the form of a substantially rigid column having lower and upper ends, the lower end being attached to the base and the camera platform being attached to the upper end.

6. A camera mount as claimed in claim 5, wherein said column is tubular and the lower end thereof encircles the base, and the upper end encircles the camera platform.

7. A camera mount as claimed in claim 6, wherein at least one aperture is provided in the column adjacent the platform, whereby access may be gained to the camera mount screw from below the platform.

8. A camera mount as claimed in claim 1, wherein the support provides at least one surface for carrying information.

9. A camera mount as claimed in claim 8, wherein the support provides at least one planar surface for carrying advertising material.

10. A camera mount as claimed in claim 1, wherein the support includes a shroud enclosing and surrounding the space between the base and the platform.

11. A camera mount as claimed in claim 10, wherein the shroud is profiled to have a recognisable shape indicative of a particular commercial product.

12. A camera mount as claimed in claim 10, wherein at least one aperture is provided in the shroud adjacent the platform, whereby access may be gained to the camera mount screw from below the platform.
